(19) United States
(12) Patent Application Publication
(10) Pub. No.: US 2026/0087349 A1
(43) Pub. Date: Mar. 26, 2026

(54) HIERARCHICAL SELF-SUPERVISED VISUAL LANGUAGE MODEL WITH MEDICAL IMAGE LOCALIZATION

(71) Applicant: Siemens Healthineers AG, Forchheim (DE)

(72) Inventors: Bogdan Georgescu, Princeton, NJ (US); Awais Mansoor, Potomac, MD (US); Sasa Grbic, Plainsboro, NJ (US); Dorin Comaniciu, Princeton, NJ (US)

(21) Appl. No.: 18/897,090

(22) Filed: Sep. 26, 2024

(51) Int. Cl. G06N 3/088; G06T 7/00

(52) U.S. Cl. CPC G06N 3/088; G06T 7/0014; G06T 2207/20081; G06T 2207/20084

(57) ABSTRACT

Systems and methods for determining a correction between an input text-based query and one or more input medical images are provided. An input text-based query and one or more input medical images are received. The input text-based query is encoded into text features using a machine learning based text encoder network. The one or more input medical images are encoded into a spatial hierarchy of image features using a machine learning based image encoder network. A correlation is determined between the text features and the image features from a top-down of the spatial hierarchy of image features using the machine learning based text encoder network. The correlation between the text features and the image features is output.

### TECHNICAL FIELD

The present invention relates generally to AI/ML (artificial intelligence/machine learning) for medical data analysis, and in particular to hierarchical self-supervised visual language model with medical image localization.

### BACKGROUND

Recently, AI/ML models have been proposed for performing various medical analysis tasks. Conventional AI/ML models are typically trained for performing medical analysis tasks with supervised learning using curated annotated training data. However, scaling such AI/ML models is limited by the large amount of curated annotated training data required for training, which increases with the number and complexity of the tasks. There is significant cost in curating and annotating imaging medical imaging data at very large scales for training robust, high-performing AI/ML models.

VLMs (visual language models) are a type of machine learning model that integrates both visual and textual information. VLMs address the challenges associated with training conventional AI/ML models via supervised learning by learning rich vision-language correlations from very large-scale database of image-report pairs. Self-supervised training of VLMs result in aligned semantic information of the reports with the image content and can potentially significantly reduce the need for such a large number of annotated training data. However, VLMs typically use global image features that are aligned with the text features. There is no localization information being learned between the text features and the image. This limits the applicability of VLMs to object detection tasks, particularly for semantic concepts that align with smaller local image regions such as small abnormalities.

### BRIEF SUMMARY OF THE INVENTION

In accordance with one or more embodiments, systems and methods for determining a correction between an input text-based query and one or more input medical images are provided. An input text-based query and one or more input medical images are received. The input text-based query is encoded into text features using a machine learning based text encoder network. The one or more input medical images are encoded into a spatial hierarchy of image features using a machine learning based image encoder network. A correlation is determined between the text features and the spatial hierarchy of image features according to a top-down analysis of the spatial hierarchy of image features using the machine learning based text encoder network. The correlation between the text features and the spatial hierarchy of image features is output.

In one embodiment, a correlation score is determined for each respective image feature of the spatial hierarchy of image features. The correlation score represents a correlation between the respective image feature and the text features. Highly correlated image features of the spatial hierarchy of image feature are determined based on the correlation scores. Regions corresponding to the highly correlated image features are mapped to the one or more input medical images.

In one embodiment, the machine learning based encoder network is trained by receiving a training text-based query and one or more training medical images. The training text-based query is encoded into training text features using the machine learning based text encoder network. The one or more training medical images are encoded into a spatial hierarchy of training image features using the machine learning based image encoder network. A subset of the spatial hierarchy of training image features is selected based on correlations between particular features of the spatial hierarchy of training image features and the text features. The machine learning based text encoder network is trained for determining a correlation between input text features and input image features based on the text features and the selected subset of the spatial hierarchy of training image features. The trained machine learning based text encoder network is output.

In one embodiment, a correlation between each feature of the spatial hierarchy of training image features and the text features is determined. The features of the spatial hierarchy of training image features with a highest correlation are selected as the subset of the spatial hierarchy of training image features. In another embodiment, a correlation between each feature of the spatial hierarchy of training image features and image features of one or more example images known to be correlated with the training text-based query is determined. The subset of the spatial hierarchy of training image features is selected based on the on the correlation. In other embodiments, the machine learning based text encoder network is trained using contrastive learning. The selected subset of the spatial hierarchy of training image features and the text features are used as positive examples and unselected image features of the spatial hierarchy of training image features and the text features are used as negative examples.

In one embodiment, the machine learning based text encoder network comprises a language model.

In accordance with one or more embodiments, systems and methods for training a machine learning based text encoder network for determining a correction between an input text-based query and one or more input medical images are provided. A training text-based query and one or more training medical images are received. The training text-based query are encoded into training text features using a machine learning based text encoder network. The one or more training medical images are encoded into a spatial hierarchy of image features using a machine learning based image encoder network. A subset of the spatial hierarchy of image features is selected based on correlations between particular features of the spatial hierarchy of image features and the text features. The machine learning based text encoder network is trained for determining a correlation between input text features and input image features based on the text features and the selected subset of the spatial hierarchy of image features. The trained machine learning based text encoder network is output.

These and other advantages of the invention will be apparent to those of ordinary skill in the art by reference to the following detailed description and the accompanying drawings.

### BRIEF DESCRIPTION OF THE DRAWINGS

FIG. 1 shows a method for training a VLM for determining a correlation between text features and image features, in accordance with one or more embodiments;

FIG. 2 shows a workflow for training a VLM for determining a correlation between text features and image features, in accordance with one or more embodiments;

FIG. 3 shows a method for determining a correlation between text features and image features, in accordance with one or more embodiments;

FIG. 4 shows a workflow for determining a correlation between text features and image features, in accordance with one or more embodiments;

FIG. 5 shows an exemplary artificial neural network that may be used to implement one or more embodiments;

FIG. 6 shows a convolutional neural network that may be used to implement one or more embodiments;

FIG. 7 shows a schematic structure of a recurrent machine learning model that may be used to implement one or more embodiments; and

FIG. 8 shows a high-level block diagram of a computer that may be used to implement one or more embodiments.

### DETAILED DESCRIPTION

The present invention generally relates to methods and systems for hierarchical self-supervised visual language model with image localization. Embodiments of the present invention are described herein to give a visual understanding of such methods and systems. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

Embodiments described herein provide for the training of VLMs to provide a spatially hierarchical alignment of localized image features with text features in a fully self-supervised manner and without requiring a hypothesis generator. Such VLMs are trained with contrastive learning using a subset of a spatial hierarchy of image features that highly correlate with text features. Advantageously, such VLMs can be used to potentially overcome the complexity of scaling high-performance AI/ML systems to new concepts in the text features as well as providing location information for the image features corresponding to the new concepts.

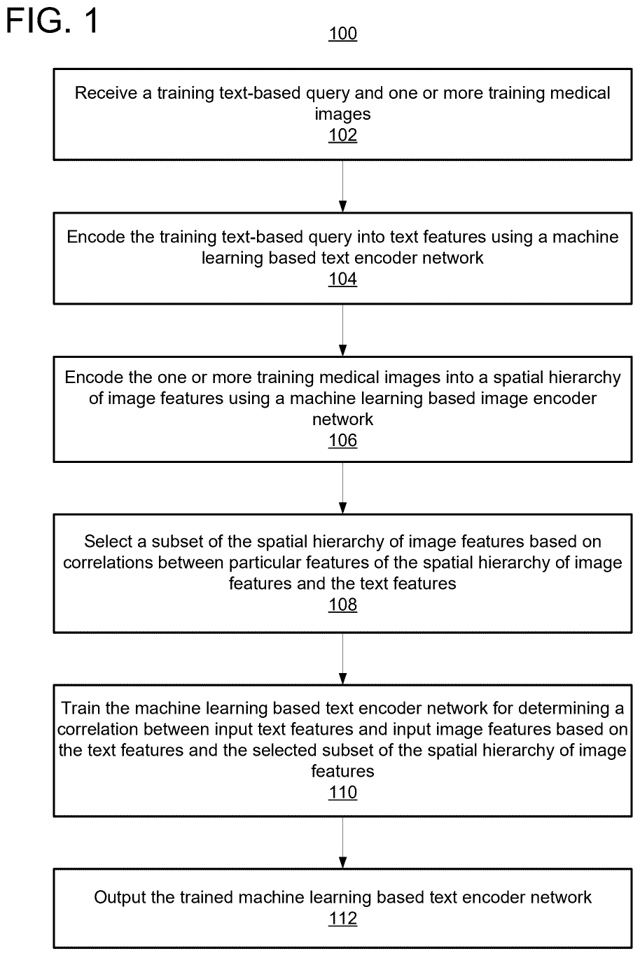

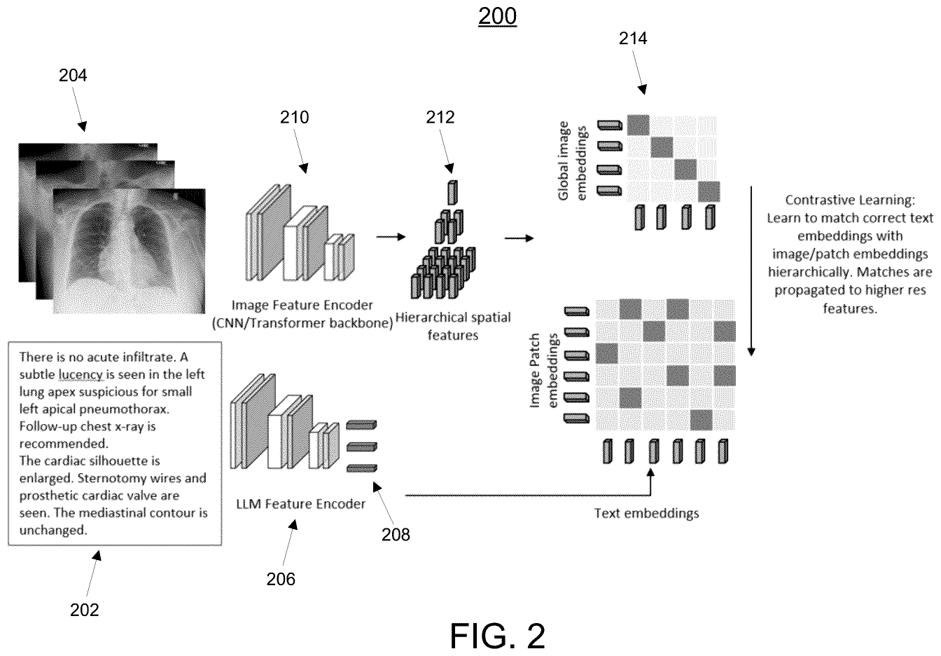

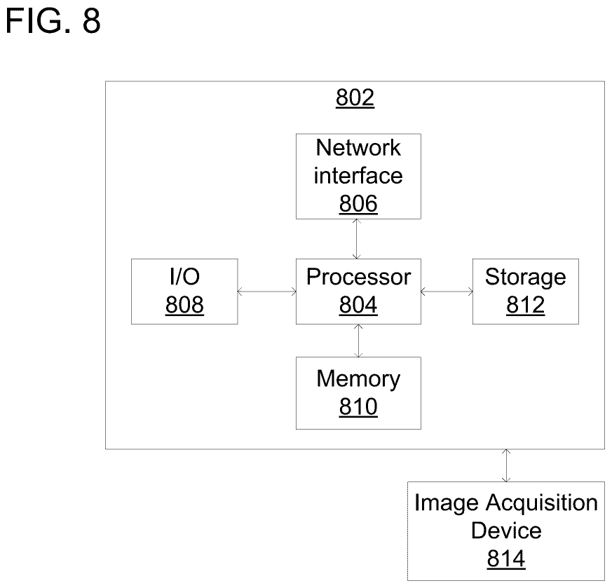

FIG. 1 shows a method 100 for training a VLM for determining a correlation between text features and image features, in accordance with one or more embodiments. The steps and sub-steps of method 100 may be performed by one or more suitable computing devices, such as, e.g., computer 802 of FIG. 8. FIG. 2 shows a workflow 200 for training a VLM for determining a correlation between text features and image features, in accordance with one or more embodiments. Method 100 of FIG. 1 and workflow 200 of FIG. 2 are performed during an offline or training stage for training the VLM. FIG. 1 and FIG. 2 will be described together.

At step 102 of FIG. 1, a training text-based query and one or more training medical images are received.

The training text-based query may comprise text-based commands, instructions, or any other information. The training text-based query may be a natural language text-based query or in any other suitable form. In one embodiment, the training text-based query may comprise an entire medical report or impression or portions (e.g., sentences or paragraphs) thereof. In one example, as shown in workflow 200 of FIG. 2, the training text-based query is text-based query 202, which comprises: “There is no acute infiltrate. A subtle lucency is seen in the left lung apex suspicious for small left apical pneumothorax. Follow-up chest x-ray is recommended. The cardiac silhouette is enlarged. Sternotomy wires and prosthetic cardiac valve are seen. The mediastinal contour is unchanged.”

The one or more training medical images may depict an anatomical object, such as, e.g., organs, bones, vessels, tumors or other abnormalities, or any other anatomical object of interest of a patient. The one or more training medical images are associated with the training text-based query. For example, the one or more training medical images may depict an anatomical object and the training text-based query may describe the anatomical object. The one or more medical images may be of any suitable modality, such as, e.g., MRI (magnetic resonance imaging), PET (positron emission tomography), SPECT (single photon emission computed tomography), CT (computed tomography), US (ultrasound), x-ray, or any other medical imaging modality or combinations of medical imaging modalities. The one or more training medical images may be 2D (two dimensional) images and/or 3D (three dimensional) volumes, and may comprise a single image or a plurality of images. In one example, as shown in workflow 200 of FIG. 2, the one or more training medical images are medical images 204.

The training text-based query and/or one or more training medical images may be received, for example, by directly receiving the training text-based query and/or one or more training medical images from a user via an input/output (I/O) device (e.g., I/O 808 of FIG. 8), by directly receiving the one or more training medical images from an medical image acquisition device (e.g., image acquisition device 814 of FIG. 8) as the images are acquired, by loading the training text-based query and/or one or more training medical images from a storage or memory of a computer system (e.g., storage 812 or memory 810 of computer 802 of FIG. 8), or by receiving the training text-based query and/or one or more training medical images from a remote computer system (e.g., computer 802 of FIG. 8). Such a computer system or remote computer system may comprise one or more patient databases, such as, e.g., an EHR (electronic health record), EMR (electronic medical record), PHR (personal health record), HIS (health information system), RIS (radiology information system), PACS (picture archiving and communication system), LIMS (laboratory information management system), or any other suitable database or system.

At step 104 of FIG. 1, the training text-based query is encoded into text features using a machine learning based text encoder network. In one example, as shown in workflow 200 of FIG. 2, text-based query 202 is encoded into text embeddings or features 208 by LLM (large language model) feature encoder 206. The text features are compact, fixed-size representations or embeddings (e.g., vectors) that characterize the semantic concepts in the training text-based query.

The machine learning based text encoder network receives as input the training text-based query and generates as output the text features. The machine learning based text encoder network may be implemented according to any suitable machine learning based architecture. In one embodiment, the machine learning based text encoder network is a language model, such as, e.g., an LLM. However, the language model may be any other suitable language model. For example, the language model may be a small language model, which uses a relatively smaller neural network, has fewer parameters, and is trained on less training data as compared with an LLM.

The LLM may be any suitable pretrained deep learning based LLM. For example, the LLM may be based on the transformer architecture, which uses an attention mechanism to capture long-range dependencies in text. One example of a transformer-based architecture is GPT (generative pre-training transformer), such as, e.g., bioGPT, which has a multilayer transformer decoder architecture that may be pretrained to optimize the next token prediction task and then fine-tuned with labelled data for various downstream tasks. Other exemplary transformer-based architectures include BLOOM (BigScience Large Open-science Open-access Multilingual Language Model), BERT (Bidirectional Encoder Representations from Transformers), and LLAMA (large language model Meta AI).

At step 106 of FIG. 1, the one or more training medical images are encoded into a spatial hierarchy of image features using a machine learning based image encoder network. In one example, as shown in workflow 200 of FIG. 2, medical images 204 are encoded into hierarchical spatial image features 212 by image feature encoder 210.

The image features are compact, fixed-size representations or embeddings (e.g., vectors) of the one or more training medical images. The image features are hierarchically and spatially arranged. At the top of the spatial hierarchy is a single global image feature representing the entirety of the one or more training medical images. From the top-down, the spatial hierarchy of image features are of increasing numbers of patch image features representing increasingly smaller localized regional patches of the one or more training medical images.

The machine learning based image encoder network receives as input the one or more training medical images and generates as output the spatial hierarchy of image features. The machine learning based image encoder network may be implemented according to any suitable machine learning based architecture. For example, the machine learning based image encoder network may be implemented as a CNN (convolutional neural network) or with a ViT (visual transformer) neural network. The CNN architecture down-samples the one or more training medical images on a coarser grid while the ViT neural network linearized tokens can be re-mapped to a coarser grid, thus resulting in spatial image features. From the spatial image features, a spatial hierarchy of spatial image features is provided by combining features in a pooling region, for example, by linear combination, max/average pooling, etc. The machine learning based text encoder network and the machine learning based image encoder network together from a VLM.

At step 108 of FIG. 1, a subset of the spatial hierarchy of image features is selected based on correlations between particular features of the spatial hierarchy of image features and the text features. The subset of the spatial hierarchy of image features may be selected according to any suitable approach.

In one embodiment, the subset of the spatial hierarchy of image features is selected by determining the current correlation between the spatial hierarchy of image features and the text features. Starting from the top down, the correlation between features at a respective level of the spatial hierarchy of image features and the text features are computed. The highest correlating features at the respective level of the spatial hierarchy of image features are then selected, e.g., based on a threshold or a top N features (where N is any positive integer). This process is iteratively repeated moving down each hierarchical level of the spatial hierarchy of image features.

In another embodiment, the subset of the spatial hierarchy of image features is selected based on additional image features (encoded by the same machine learning based image encoder network) of one or more example images known to be correlated with the training text-based query. A correlation between the additional image features and the spatial hierarch of image features is computed and highly correlated image features of the spatial hierarch of image features are selected as the subset of the spatial hierarchy of image features. The highly correlated image features may be selected, for example, as a top N highest correlated image features (where N is any positive integer) or the image features having a correlation that satisfy a minimum correlation threshold. This approach assumes that image features for the one or more training medical images will be similar in the feature space to at least one of the additional image features of the one or more example images and thus thye cluster together around the additional image features. The additional image features act as anchors or cluster centers in the feature space to which the image features are to converge if the corresponding concept represented by the text features is present.

At step 110 of FIG. 1, the machine learning based text encoder network is trained for determining a correlation between input text features and input image features based on the text features and the selected subset of the spatial hierarchy of image features. The input text features represent text features encoded from an input text-based query using the machine learning based text encoder network. The input image features represent image features encoded from one or more input medical images using the machine learning based image encoder network. In one example, as shown in workflow 200 of FIG. 2, LLM feature encoder 206 learns to determine correlations 214 between text features 208 and hierarchical spatial image features 212 according to a top-down analysis, starting from global image features or embeddings at the top level and moving down to image patch features or embeddings at lower levels of the hierarchy.

The machine learning based text encoder network may be trained according to any suitable approach. In one embodiment, the machine learning based text encoder network is trained using contrastive learning. In contrastive learning, the machine learning based encoder network learns to determine correlations by contrasting positive examples and negative examples. The positive examples may comprise the selected subset of the spatial hierarchy of image features and the text features. The negative examples may comprise random image features that were not selected and the text features. The machine learning based text encoder network is hierarchically trained, using image features from the selected subset of the spatial hierarchy from top-down, starting with the global image features at the top level and moving down the spatial hierarchy to patch image features. In one embodiment, the machine learning based image encoder network is also trained for determining the correlation between the input text features and the input image features at step 110 of FIG. 1.

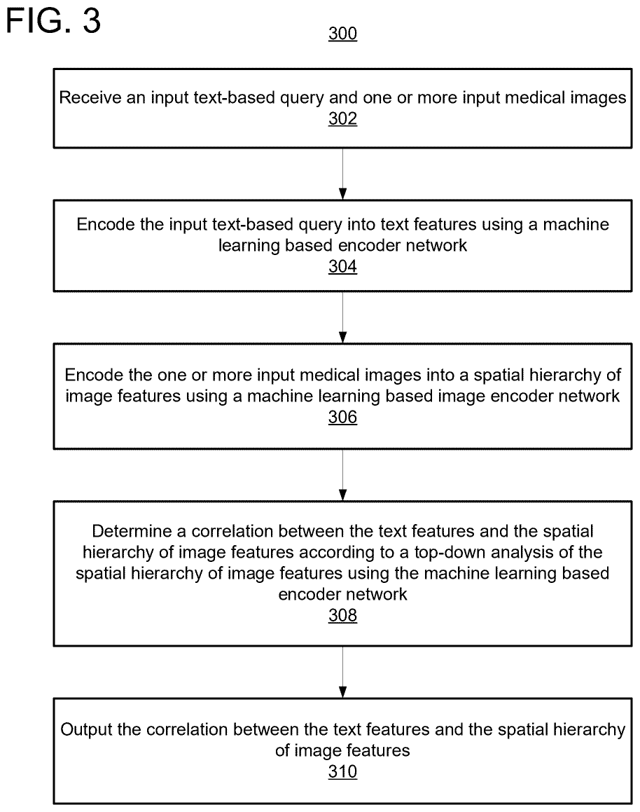

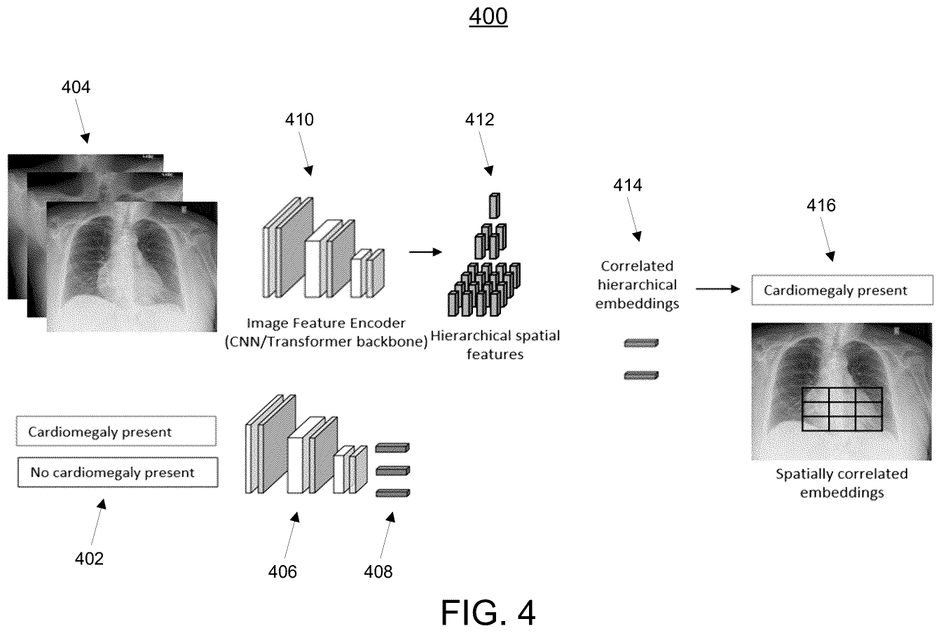

At step 112 of FIG. 1, the trained machine learning based text encoder network is output. For example, the trained machine learning based text encoder network can be output by storing the trained machine learning based text encoder network on a memory or storage of a computer system (e.g., memory 810 or storage 812 of computer 802 of FIG. 8) or by transmitting the trained machine learning based text encoder network to a remote computer system (e.g., computer 802 of FIG. 8). In one embodiment, the trained machine learning based text encoder network may be applied during an online or inference stage to determine a correlation between input text features and input image features, e.g., according to method 300 of FIG. 3 and workflow 400 of FIG. 4, described in detail below.

FIG. 3 shows a method 300 for determining a correlation between text features and image features, in accordance with one or more embodiments. The steps and sub-steps of method 300 may be performed by one or more suitable computing devices, such as, e.g., computer 802 of FIG. 8. FIG. 4 shows a workflow 400 for determining a correlation between text features and image features, in accordance with one or more embodiments. Method 300 of FIG. 3 and workflow 400 of FIG. 4 are performed during an online or inference stage. FIG. 3 and FIG. 4 will be described together.

At step 302 of FIG. 2, an input text-based query and one or more input medical images are received.

The input text-based query may comprise text-based commands, instructions, or any other information. The input text-based query may be a natural language text-based query or in any other suitable form. In one example, as shown in workflow 400 of FIG. 4, the input text-based query may be text-based query 402, which may comprise one of “cardiomegaly present” or “no cardiomegaly present”.

The one or more input medical images may depict an anatomical object and may be of any suitable modality or modalities. The one or more input medical images may be 2D images and/or 3D volumes, and may comprise a single image or a plurality of images. In one example, as shown in workflow 400 of FIG. 4, the one or more input medical images are medical images 404.

The input text-based query and/or one or more input medical images may be received, for example, by directly receiving the input text-based query and/or one or more input medical images from a user via an input/output (I/O) device (e.g., I/O 808 of FIG. 8), by directly receiving the one or more input medical images from an medical image acquisition device (e.g., image acquisition device 814 of FIG. 8) as the images are acquired, by loading the input text-based query and/or one or more input medical images from a storage or memory of a computer system (e.g., storage 812 or memory 810 of computer 802 of FIG. 8), or by receiving the input text-based query and/or one or more input medical images from a remote computer system (e.g., computer 802 of FIG. 8).

At step 304 of FIG. 3, the input text-based query is encoded into text features using a machine learning based encoder network. In one example, as shown in workflow 400 of FIG. 4, text-based query 402 is encoded into text embeddings or features 408 by text encoder network 406. In one embodiment, the machine learning based encoder network is the machine learning based encoder network utilized at step 104 of FIG. 1.

The machine learning based text encoder network receives as input the input text-based query and generates as output the text features. The machine learning based text encoder network may be implemented as a language model (e.g., LLM) or according to any other suitable machine learning based architecture.

At step 306 of FIG. 3, the one or more input medical images are encoded into a spatial hierarchy of image features using a machine learning based image encoder network. In one example, as shown in workflow 400 of FIG. 4, medical images 404 are encoded into hierarchical spatial image features 412 by image feature encoder 410. The machine learning based image encoder network may be the machine learning based image encoder network utilized at step 106 and trained at step 110.

The image features are hierarchically and spatially arranged. The machine learning based image encoder network receives as input the one or more input medical images and generates as output the spatial hierarchy of image features. The machine learning based image encoder network may be implemented, e.g., as a CCN or with a ViT or according to any other suitable machine learning based architecture. The machine learning based text encoder network and the machine learning based image encoder network together from a VLM.

At step 308 of FIG. 3, a correlation is determined between the text features and the spatial hierarchy of image features according to a top-down analysis of the spatial hierarchy of image features using the machine learning based encoder network. The correlation is determined using the machine learning based text encoder network as trained at step 110 of FIG. 1. In one example, as shown in workflow 400 of FIG. 4, correlated hierarchical embeddings 414 between text embeddings 408 and hierarchical spatial image features 412 by image feature encoder 410. In workflow 400, hierarchical spatial image features 412 are highly correlated with text embeddings 408 extracted from text-based query 402 of “cardiomegaly present”, thus resulting in results 416 that cardiomegaly is present in the one or more input medical images.

The correlation may be represented in any suitable format. In one embodiment, the correlation is represented as correlation scores determined for each image feature of the spatial hierarchy of image features. For example, the correlation scores may be a value between 0 and 1, where 0 represents no correlation between a respective image feature and the text features and 1 represents full correlation between the respective image feature and the text features. The correlation scores are determined for each of the features of the spatial hierarchy of image features. According to the top-down analysis of the spatial hierarchy of image features, the correlation score is first determined between the text features and the image features (i.e., the global image features) at the top level of the spatial hierarchy of image features. The correlation scores are then hierarchically determined between the text features and the image features at each lower level of the spatial hierarchy of image features for correlated parent features. In this manner, the correlation between the text features and the image features at a given lower level are only determined where the parent text features and the parent image features are correlated.

In one embodiment, the machine learning based encoder network maps regions corresponding to highly correlated image features (e.g., determined based on a threshold or a top N image features) to the one or more input medical images that correspond to the highly correlated image features. The input text-based query can thus be mapped to highly correlated regions of the one or more input medical images.

At step 112 of FIG. 1, the correlation between the text features and the spatial hierarchy of image features is output. For example, the trained machine learning based text encoder network can be output by storing the trained machine learning based text encoder network on a memory or storage of a computer system (e.g., memory 810 or storage 812 of computer 802 of FIG. 8) or by transmitting the trained machine learning based text encoder network to a remote computer system (e.g., computer 802 of FIG. 8). In one embodiment, the one or more input medical images is output with regions corresponding to the highly correlated image features identified.

Advantageously, by aligning image features with text features, reasoning can be performed in the same feature space with interchangeable features either from the one or more medical images of the text-based query. Additionally, the global image feature correlates globally with text features while patch image features can correlate with various regions of the text features corresponding to different semantic meaning. This can happen when, for example, the whole text of a report is encoded into text features and different sentences can correspond to different patch image features.

Embodiments described herein are described with respect to the claimed systems as well as with respect to the claimed methods. Features, advantages or alternative embodiments herein can be assigned to the other claimed objects and vice versa. In other words, claims and embodiments for the systems can be improved with features described or claimed in the context of the respective methods. In this case, the functional features of the method are implemented by physical units of the system.

Furthermore, certain embodiments described herein are described with respect to methods and systems utilizing trained machine learning models, as well as with respect to methods and systems for providing trained machine learning models. Features, advantages or alternative embodiments herein can be assigned to the other claimed objects and vice versa. In other words, claims and embodiments for providing trained machine learning models can be improved with features described or claimed in the context of utilizing trained machine learning models, and vice versa. In particular, datasets used in the methods and systems for utilizing trained machine learning models can have the same properties and features as the corresponding datasets used in the methods and systems for providing trained machine learning models, and the trained machine learning models provided by the respective methods and systems can be used in the methods and systems for utilizing the trained machine learning models.

In general, a trained machine learning model mimics cognitive functions that humans associate with other human minds. In particular, by training based on training data the machine learning model is able to adapt to new circumstances and to detect and extrapolate patterns. Another term for “trained machine learning model” is “trained function.”

In general, parameters of a machine learning model can be adapted by means of training. In particular, supervised training, semi-supervised training, unsupervised training, reinforcement learning and/or active learning can be used. Furthermore, representation learning (an alternative term is “feature learning”) can be used. In particular, the parameters of the machine learning models can be adapted iteratively by several steps of training. In particular, within the training a certain cost function can be minimized. In particular, within the training of a neural network the backpropagation algorithm can be used.

In particular, a machine learning model, such as, e.g., the machine learning based text encoder network and the machine learning based image encoder network utilized in method 100 of FIG. 1, LLM feature encoder 206 and image feature encoder 210 of FIG. 2, the machine learning based text encoder network and the machine learning based image encoder network utilized in method 300 of FIG. 3, and text encoder network 406 and image feature encoder 410 of FIG. 4, can comprise, for example, a neural network, a support vector machine, a decision tree and/or a Bayesian network, and/or the machine learning model can be based on, for example, k-means clustering, Q-learning, genetic algorithms and/or association rules. In particular, a neural network can be, e.g., a deep neural network, a convolutional neural network or a convolutional deep neural network. Furthermore, a neural network can be, e.g., an adversarial network, a deep adversarial network and/or a generative adversarial network.

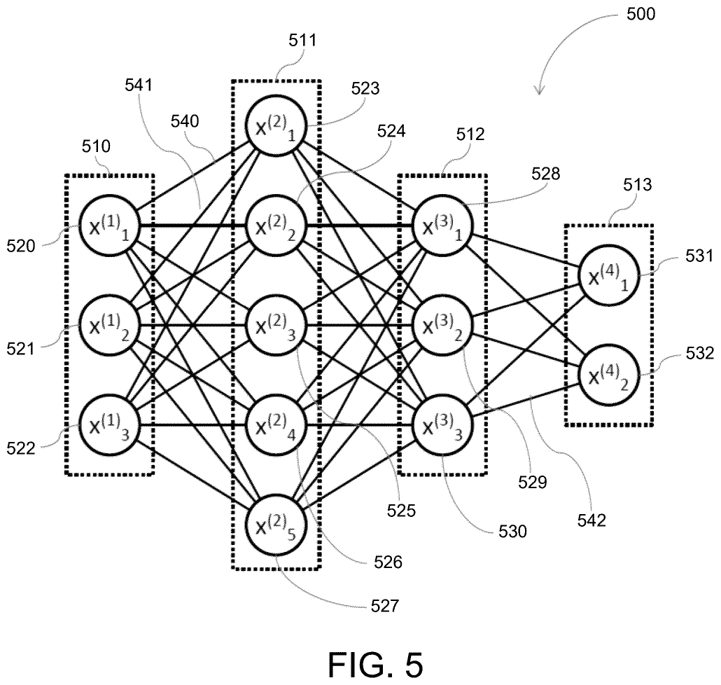

FIG. 5 shows an embodiment of an artificial neural network 500 that may be used to implement one or more machine learning models described herein. Alternative terms for “artificial neural network” are “neural network”, “artificial neural net” or “neural net”.

The artificial neural network 500 comprises nodes 520, . . . , 532 and edges 540, . . . 542, wherein each edge 540, . . . , 542 is a directed connection from a first node 520, . . . , 532 to a second node 520, . . . , 532. In general, the first node 520, . . . , 532 and the second node 520, . . . , 532 are different nodes 520, . . . , 532, it is also possible that the first node 520, . . . , 532 and the second node 520, . . . , 532 are identical. For example, in FIG. 5 the edge 540 is a directed connection from the node 520 to the node 523, and the edge 542 is a directed connection from the node 530 to the node 532. An edge 540, . . . , 542 from a first node 520, 532 to a second node 520, . . . , 532 is also denoted as “ingoing edge” for the second node 520, . . . , 532 and as “outgoing edge” for the first node 520, . . . , 532.

In this embodiment, the nodes 520, . . . , 532 of the artificial neural network 500 can be arranged in layers 510, . . . , 513, wherein the layers can comprise an intrinsic order introduced by the edges 540, . . . , 542 between the nodes 520, . . . , 532. In particular, edges 540, . . . , 542 can exist only between neighboring layers of nodes. In the displayed embodiment, there is an input layer 510 comprising only nodes 520, . . . , 522 without an incoming edge, an output layer 513 comprising only nodes 531, 532 without outgoing edges, and hidden layers 511, 512 in-between the input layer 510 and the output layer 513. In general, the number of hidden layers 511, 512 can be chosen arbitrarily. The number of nodes 520, . . . , 522 within the input layer 510 usually relates to the number of input values of the neural network, and the number of nodes 531, 532 within the output layer 513 usually relates to the number of output values of the neural network.

In particular, a (real) number can be assigned as a value to every node 520, . . . , 532 of the neural network 500. Here, x⁽ⁿ⁾ᵢ denotes the value of the i-th node 520, . . . 532 of the n-th layer 510, . . . , 513. The values of the nodes 520, . . . , 522 of the input layer 510 are equivalent to the input values of the neural network 500, the values of the nodes 531, 532 of the output layer 513 are equivalent to the output value of the neural network 500. Furthermore, each edge 540, . . . , 542 can comprise a weight being a real number, in particular, the weight is a real number within the interval [−1, 1] or within the interval [0, 1]. Here, w^{(m,n)}_{i,j} denotes the weight of the edge between the i-th node 520, . . . , 532 of the m-th layer 510, . . . , 513 and the j-th node 520, . . . , 532 of the n-th layer 510, . . . , 513. Furthermore, the abbreviation w⁽ⁿ⁾_{i,j} is defined for the weight w^{(n,n+1)}_{i,j}.

In particular, to calculate the output values of the neural network 500, the input values are propagated through the neural network. In particular, the values of the nodes 520, . . . , 532 of the (n+1)-th layer 510, . . . , 513 can be calculated based on the values of the nodes 520, . . . , 532 of the n-th layer 510, . . . , 513 by

$${x}^{{( n + 1 )}_{j}} = f ( {\sum }_{i} {x}^{{( n )}_{i}} \cdot {w}^{{( n )}_{i , j}} ) .$$

Herein, the function f is a transfer function (another term is “activation function”). Known transfer functions are step functions, sigmoid function (e.g., the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 510 are given by the input of the neural network 500, wherein values of the first hid-den layer 511 can be calculated based on the values of the input layer 510 of the neural network, wherein values of the second hidden layer 512 can be calculated based in the values of the first hidden layer 511, etc.

In order to set the values w^{(m,n)}_{i,j} for the edges, the neural network 500 has to be trained using training data. In particular, training data comprises training input data and training output data (denoted as tᵢ). For a training step, the neural network 500 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 500 (backpropagation algorithm). In particular, the weights are changed according to

$${w}^{{′ ( n )}_{i , j}} = {w}^{{( n )}_{i , j}} - γ \cdot {δ}^{{( n )}_{j}} \cdot {x}^{{( n )}_{i}}$$

wherein γ is a learning rate, and the numbers δ⁽ⁿ⁾ⱼ can be recursively calculated as

$${δ}^{{( n )}_{j}} = ( {\sum }_{k} {δ}^{{( n + 1 )}_{k}} \cdot {w}^{{( n + 1 )}_{j , k}} ) \cdot {f}^{′} ( {\sum }_{i} {x}^{{( n )}_{i}} \cdot {w}^{{( n )}_{i , j}} )$$

based on δ⁽ⁿ⁺¹⁾ⱼ, if the (n+1)-th layer is not the output layer, and

$${δ}^{{( n )}_{j}} = ( {x}^{{( n + 1 )}_{j}} - {t}^{{( n + 1 )}_{j}} ) \cdot {f}^{′} ( {x}^{{( n )}_{i}} \cdot {w}^{{( n )}_{i , j}} )$$

if the (n+1)-th layer is the output layer 513, wherein f′ is the first derivative of the activation function, and t⁽ⁿ⁺¹⁾ⱼ is the comparison training value for the j-th node of the output layer 513.

A convolutional neural network is a neural network that uses a convolution operation instead general matrix multiplication in at least one of its layers (so-called “convolutional layer”). In particular, a convolutional layer performs a dot product of one or more convolution kernels with the convolutional layer's input data/image, wherein the entries of the one or more convolution kernel are the parameters or weights that are adapted by training. In particular, one can use the Frobenius inner product and the ReLU activation function. A convolutional neural network can comprise additional layers, e.g., pooling layers, fully connected layers, and normalization layers.

By using convolutional neural networks input images can be processed in a very efficient way, because a convolution operation based on different kernels can extract various image features, so that by adapting the weights of the convolution kernel the relevant image features can be found during training. Furthermore, based on the weight-sharing in the convolutional kernels less parameters need to be trained, which prevents overfitting in the training phase and allows to have faster training or more layers in the network, improving the performance of the network.

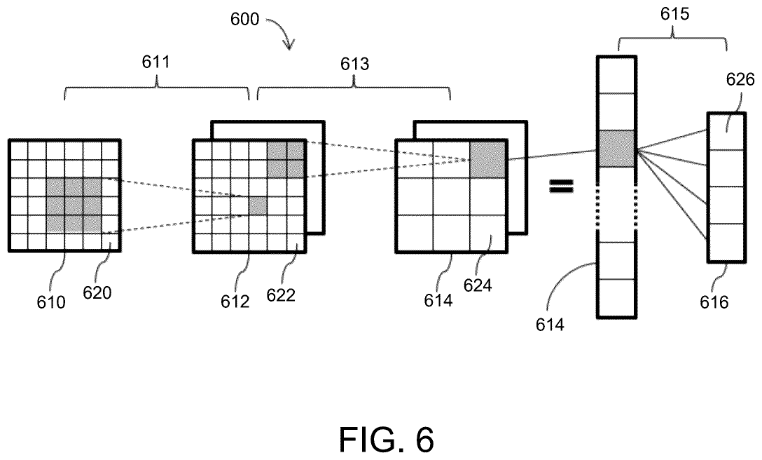

FIG. 6 shows an embodiment of a convolutional neural network 600 that may be used to implement one or more machine learning models described herein. In the displayed embodiment, the convolutional neural network comprises 600 an input node layer 610, a convolutional layer 611, a pooling layer 613, a fully connected layer 614 and an output node layer 616, as well as hidden node layers 612, 614. Alternatively, the convolutional neural network 600 can comprise several convolutional layers 611, several pooling layers 613 and several fully connected layers 615, as well as other types of layers. The order of the layers can be chosen arbitrarily, usually fully connected layers 615 are used as the last layers before the output layer 616.

In particular, within a convolutional neural network 600 nodes 620, 622, 624 of a node layer 610, 612, 614 can be considered to be arranged as a d-dimensional matrix or as a d-dimensional image. In particular, in the two-dimensional case the value of the node 620, 622, 624 indexed with i and j in the n-th node layer 610, 612, 614 can be denoted as x(n)[i, j]. However, the arrangement of the nodes 620, 622, 624 of one node layer 610, 612, 614 does not have an effect on the calculations executed within the convolutional neural network 600 as such, since these are given solely by the structure and the weights of the edges.

A convolutional layer 611 is a connection layer between an anterior node layer 610 (with node values x(n−1)) and a posterior node layer 612 (with node values x(n)). In particular, a convolutional layer 611 is characterized by the structure and the weights of the incoming edges forming a convolution operation based on a certain number of kernels. In particular, the structure and the weights of the edges of the convolutional layer 611 are chosen such that the values x(n) of the nodes 622 of the posterior node layer 612 are calculated as a convolution x(n)=K*x(n−1) based on the values x(n−1) of the nodes 620 anterior node layer 610, where the convolution * is defined in the two-dimensional case as

$${x}_{k}^{( n )} [ i , j ] = ( K * {x}^{( n - 1 )} ) [ i , j ] = {\sum }_{{i}^{′}} {\sum }_{{j}^{′}} K [ {i}^{′} , {j}^{′} ] \cdot {x}^{( n - 1 )} [ i - {i}^{′} , j - {j}^{′} ] .$$

Here the kernel K is a d-dimensional matrix (in this embodiment, a two-dimensional matrix), which is usually small compared to the number of nodes 620, 622 (e.g., a 3×3 matrix, or a 5×5 matrix). In particular, this implies that the weights of the edges in the convolution layer 611 are not independent, but chosen such that they produce said convolution equation. In particular, for a kernel being a 3×3 matrix, there are only 9 independent weights (each entry of the kernel matrix corresponding to one independent weight), irrespectively of the number of nodes 620, 622 in the anterior node layer 610 and the posterior node layer 612.

In general, convolutional neural networks 600 use node layers 610, 612, 614 with a plurality of channels, in particular, due to the use of a plurality of kernels in convolutional layers 611. In those cases, the node layers can be considered as (d+1)-dimensional matrices (the first dimension indexing the channels). The action of a convolutional layer 611 is then a two-dimensional example defined as

$${x}^{{( n )}_{b}} [ i , j ] = {\sum }_{a} {K}_{a , b} * {x}^{{( n - 1 )}_{a}} [ i , j ] = {\sum }_{a} {\sum }_{{i}^{′}} {\sum }_{{j}^{′}} {K}_{a , b} [ {i}^{′} , {j}^{′} ] \cdot {x}^{{( n - 1 )}_{a}} [ i - {i}^{′} , j - {j}^{′} ]$$

where x⁽ⁿ⁻¹⁾^{ₐ} corresponds to the a-th channel of the anterior node layer 610, x⁽ⁿ⁾^{_{b}} corresponds to the b-th channel of the posterior node layer 612 and K_{a,b} corresponds to one of the kernels. If a convolutional layer 611 acts on an anterior node layer 610 with A channels and outputs a posterior node layer 612 with B channels, there are A·B independent d-dimensional kernels K_{a,b}.

In general, in convolutional neural networks 600 activation functions are used. In this embodiment re ReLU (acronym for “Rectified Linear Units”) is used, with R(z)=max(0, z), so that the action of the convolutional layer 611 in the two-dimensional example is

$${x}^{{( n )}_{b}} [ i , j ] = R ( {\sum }_{a} ( {K}_{a , b} * {x}^{{( n - 1 )}_{a}} ) [ i , j ] = R ( {\sum }_{a} {\sum }_{{i}^{′}} {\sum }_{{j}^{′}} {K}_{a , b} [ {i}^{′} , {j}^{′} ] \cdot {x}^{{( n - 1 )}_{a}} [ i - {i}^{′} , j - {j}^{′} ] )$$

It is also possible to use other activation functions, e.g., ELU (acronym for “Exponential Linear Unit”), LeakyReLU, Sigmoid, Tanh or Softmax.

In the displayed embodiment, the input layer 610 comprises 36 nodes 620, arranged as a two-dimensional 6×6 matrix. The first hidden node layer 612 comprises 72 nodes 622, arranged as two two-dimensional 6×6 matrices, each of the two matrices being the result of a convolution of the values of the input layer with a 3×3 kernel within the convolutional layer 611. Equivalently, the nodes 622 of the first hidden node layer 612 can be interpreted as arranged as a three-dimensional 2×6×6 matrix, wherein the first dimension correspond to the channel dimension.

The advantage of using convolutional layers 611 is that spatially local correlation of the input data can exploited by enforcing a local connectivity pattern between nodes of adjacent layers, in particular by each node being connected to only a small region of the nodes of the preceding layer.

A pooling layer 613 is a connection layer between an anterior node layer 612 (with node values x(n−1)) and a posterior node layer 614 (with node values x(n)). In particular, a pooling layer 613 can be characterized by the structure and the weights of the edges and the activation function forming a pooling operation based on a non-linear pooling function f. For example, in the two-dimensional case the values x(n) of the nodes 624 of the posterior node layer 614 can be calculated based on the values x(n−1) of the nodes 622 of the anterior node layer 612 as

$${x}^{{( n )}_{b}} [ i , j ] = f ( {x}^{( n - 1 )} [ {id}_{1} , {jd}_{2} ] , … , {x}^{{( n - 1 )}_{b}} [ ( i + 1 ) {d}_{1} - 1 , ( j + 1 ) {d}_{2} - 1 ] )$$

In other words, by using a pooling layer 613 the number of nodes 622, 624 can be reduced, by re-placing a number d1·d2 of neighboring nodes 622 in the anterior node layer 612 with a single node 622 in the posterior node layer 614 being calculated as a function of the values of said number of neighboring nodes. In particular, the pooling function f can be the max-function, the average or the L2-Norm. In particular, for a pooling layer 613 the weights of the incoming edges are fixed and are not modified by training.

The advantage of using a pooling layer 613 is that the number of nodes 622, 624 and the number of parameters is reduced. This leads to the amount of computation in the network being reduced and to a control of overfitting.

In the displayed embodiment, the pooling layer 613 is a max-pooling layer, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

In general, the last layers of a convolutional neural network 600 are fully connected layers 615. A fully connected layer 615 is a connection layer between an anterior node layer 614 and a posterior node layer 616. A fully connected layer 613 can be characterized by the fact that a majority, in particular, all edges between nodes 614 of the anterior node layer 614 and the nodes 616 of the posterior node layer are present, and wherein the weight of each of these edges can be adjusted individually.

In this embodiment, the nodes 624 of the anterior node layer 614 of the fully connected layer 615 are displayed both as two-dimensional matrices, and additionally as non-related nodes (indicated as a line of nodes, wherein the number of nodes was reduced for a better presentability). This operation is also denoted as “flattening”. In this embodiment, the number of nodes 626 in the posterior node layer 616 of the fully connected layer 615 smaller than the number of nodes 624 in the anterior node layer 614. Alternatively, the number of nodes 626 can be equal or larger.

Furthermore, in this embodiment the Softmax activation function is used within the fully connected layer 615. By applying the Softmax function, the sum the values of all nodes 626 of the output layer 616 is 1, and all values of all nodes 626 of the output layer 616 are real numbers between 0 and 1. In particular, if using the convolutional neural network 600 for categorizing input data, the values of the output layer 616 can be interpreted as the probability of the input data falling into one of the different categories.

In particular, convolutional neural networks 600 can be trained based on the backpropagation algorithm. For preventing overfitting, methods of regularization can be used, e.g., dropout of nodes 620, . . . , 624, stochastic pooling, use of artificial data, weight decay based on the L1 or the L2 norm, or max norm constraints.

According to an aspect, the machine learning model may comprise one or more residual networks (ResNet). In particular, a ResNet is an artificial neural network comprising at least one jump or skip connection used to jump over at least one layer of the artificial neural network. In particular, a ResNet may be a convolutional neural network comprising one or more skip connections respectively skipping one or more convolutional layers. According to some examples, the ResNets may be represented as m-layer ResNets, where m is the number of layers in the corresponding architecture and, according to some examples, may take values of 34, 50, 101, or 152. According to some examples, such an m-layer ResNet may respectively comprise (m−2)/2 skip connections.

A skip connection may be seen as a bypass which directly feeds the output of one preceding layer over one or more bypassed layers to a layer succeeding the one or more bypassed layers. Instead of having to directly fit a desired mapping, the bypassed layers would then have to fit a residual mapping “balancing” the directly fed output.

Fitting the residual mapping is computationally easier to optimize than the directed mapping. What is more, this alleviates the problem of vanishing/exploding gradients during optimization upon training the machine learning models: if a bypassed layer runs into such problems, its contribution may be skipped by regularization of the directly fed output. Using ResNets thus brings about the advantage that much deeper networks may be trained.

In particular, a recurrent machine learning model is a machine learning model whose output does not only depend on the input value and the parameters of the machine learning model adapted by the training process, but also on a hidden state vector, wherein the hidden state vector is based on previous inputs used on for the recurrent machine learning model. In particular, the recurrent machine learning model can comprise additional storage states or additional structures that incorporate time delays or comprise feedback loops.

In particular, the underlying structure of a recurrent machine learning model can be a neural network, which can be denoted as recurrent neural network. Such a recurrent neural network can be described as an artificial neural network where connections between nodes form a directed graph along a temporal sequence. In particular, a recurrent neural network can be interpreted as directed acyclic graph. In particular, the recurrent neural network can be a finite impulse recurrent neural network or an infinite impulse recurrent neural network (wherein a finite impulse network can be unrolled and replaced with a strictly feedforward neural network, and an infinite impulse network cannot be unrolled and replaced with a strictly feedforward neural network).

In particular, training a recurrent neural network can be based on the BPTT algorithm (acronym for “backpropagation through time”), on the RTRL algorithm (acronym for “real-time recurrent learning”) and/or on genetic algorithms.

By using a recurrent machine learning model input data comprising sequences of variable length can be used. In particular, this implies that the method cannot be used only for a fixed number of input datasets (and needs to be trained differently for every other number of input datasets used as input), but can be used for an arbitrary number of input datasets. This implies that the whole set of training data, independent of the number of input datasets contained in different sequences, can be used within the training, and that training data is not reduced to training data corresponding to a certain number of successive input datasets.

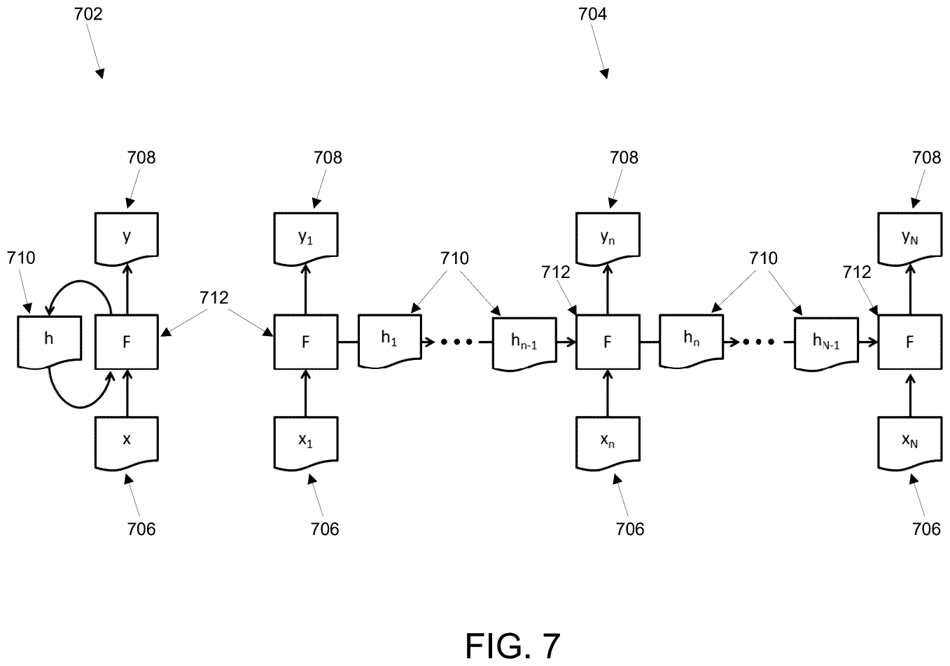

FIG. 7 shows the schematic structure of a recurrent machine learning model F, both in a recurrent representation 702 and in an unfolded representation 704, that may be used to implement one or more machine learning models described herein. The recurrent machine learning model takes as input several input datasets x, x₁, . . . , x_{N} 706 and creates a corresponding set of output datasets y, y₁, . . . , y_{N} 708. Furthermore, the output depends on a so-called hidden vector h, h₁, . . . , h_{N} 710, which implicitly comprises information about input datasets previously used as input for the recurrent machine learning model F 712. By using these hidden vectors h, h₁, . . . , h_{N} 710, a sequentiality of the input datasets can be leveraged.

In a single step of the processing, the recurrent machine learning model F 712 takes as input the hidden vector hₙ₋₁ created within the previous step and an input dataset xₙ. Within this step, the recurrent machine learning model F generates as output an updated hidden vector hₙ and an output dataset yₙ. In other words, one step of processing calculates (yₙ, hₙ)=F (xₙ, hₙ₋₁), or by splitting the recurrent machine learning model F 712 into a part F(y) calculating the output data and F(h) calculating the hidden vector, one step of processing calculates yₙ=F^{(y)}(xₙ, hₙ₋₁) and hₙ=F^{(h)}(xₙ, hₙ₋₁). For the first processing step, h₀ can be chosen randomly or filled with all entries being zero. The parameters of the recurrent machine learning model F 712 that were trained based on training datasets before do not change between the different processing steps.

In particular, the output data and the hidden vector of a processing step depend on all the previous input datasets used in the previous steps. yₙ=F^{(y)}(xₙ, F^{(h)}(xₙ₋₁, hₙ₋₂)) and hₙ=F(h)(xₙ, F^{(h)}(xₙ₋₁, hₙ₋₂)).

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatuses, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatuses, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps or functions of the methods and workflows described herein, including one or more of the steps or functions of FIG. 1-4. Certain steps or functions of the methods and workflows described herein, including one or more of the steps or functions of FIG. 1-4, may be performed by a server or by another processor in a network-based cloud-computing system. Certain steps or functions of the methods and workflows described herein, including one or more of the steps of FIG. 1-4, may be performed by a client computer in a network-based cloud computing system. The steps or functions of the methods and workflows described herein, including one or more of the steps of FIG. 1-4, may be performed by a server and/or by a client computer in a network-based cloud computing system, in any combination.

Systems, apparatuses, and methods described herein may be implemented using a computer program product tangibly embodied in an information carrier, e.g., in a non-transitory machine-readable storage device, for execution by a programmable processor; and the method and workflow steps described herein, including one or more of the steps or functions of FIG. 1-4, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an example computer 802 that may be used to implement systems, apparatuses, and methods described herein is depicted in FIG. 8. Computer 802 includes a processor 804 operatively coupled to a data storage device 812 and a memory 810. Processor 804 controls the overall operation of computer 802 by executing computer program instructions that define such operations. The computer program instructions may be stored in data storage device 812, or other computer readable medium, and loaded into memory 810 when execution of the computer program instructions is desired. Thus, the method and workflow steps or functions of FIG. 1-4 can be defined by the computer program instructions stored in memory 810 and/or data storage device 812 and controlled by processor 804 executing the computer program instructions. For example, the computer program instructions can be implemented as computer executable code programmed by one skilled in the art to perform the method and workflow steps or functions of FIG. 1-4. Accordingly, by executing the computer program instructions, the processor 804 executes the method and workflow steps or functions of FIG. 1-4. Computer 802 may also include one or more network interfaces 806 for communicating with other devices via a network. Computer 802 may also include one or more input/output devices 808 that enable user interaction with computer 802 (e.g., display, keyboard, mouse, speakers, buttons, etc.).

Processor 804 may include both general and special purpose microprocessors, and may be the sole processor or one of multiple processors of computer 802. Processor 804 may include one or more central processing units (CPUs), for example. Processor 804, data storage device 812, and/or memory 810 may include, be supplemented by, or incorporated in, one or more application-specific integrated circuits (ASICs) and/or one or more field programmable gate arrays (FPGAs).

Data storage device 812 and memory 810 each include a tangible non-transitory computer readable storage medium. Data storage device 812, and memory 810, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 808 may include peripherals, such as a printer, scanner, display screen, etc. For example, input/output devices 808 may include a display device such as a cathode ray tube (CRT) or liquid crystal display (LCD) monitor for displaying information to the user, a keyboard, and a pointing device such as a mouse or a trackball by which the user can provide input to computer 802.

An image acquisition device 814 can be connected to the computer 802 to input image data (e.g., medical images) to the computer 802. It is possible to implement the image acquisition device 814 and the computer 802 as one device. It is also possible that the image acquisition device 814 and the computer 802 communicate wirelessly through a network. In a possible embodiment, the computer 802 can be located remotely with respect to the image acquisition device 814.

Any or all of the systems, apparatuses, and methods discussed herein may be implemented using one or more computers such as computer 802.

One skilled in the art will recognize that an implementation of an actual computer or computer system may have other structures and may contain other components as well, and that FIG. 8 is a high level representation of some of the components of such a computer for illustrative purposes.

Independent of the grammatical term usage, individuals with male, female or other gender identities are included within the term.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

The following is a list of non-limiting illustrative embodiments disclosed herein:

Illustrative embodiment 1. A computer-implemented method comprising: receiving an input text-based query and one or more input medical images; encoding the input text-based query into text features using a machine learning based text encoder network; encoding the one or more input medical images into a spatial hierarchy of image features using a machine learning based image encoder network; determining a correlation between the text features and the spatial hierarchy of image features from a top-down of the spatial hierarchy of image features using the machine learning based text encoder network; and outputting the correlation between the text features and the spatial hierarchy of image features.

Illustrative embodiment 2. The computer-implemented method of illustrative embodiment 1, wherein determining a correlation between the text features and the spatial hierarchy of image features from a top-down of the spatial hierarchy of image features using the machine learning based text encoder network comprises: determining a correlation score for each respective image feature of the spatial hierarchy of image features, the correlation score representing a correlation between the respective image feature and the text features.

Illustrative embodiment 3. The computer-implemented method of illustrative embodiment 2, wherein determining a correlation between the text features and the image features from a top-down of the spatial hierarchy of image features using the machine learning based text encoder network comprises: determining highly correlated image features of the spatial hierarchy of image feature based on the correlation scores; and mapping regions corresponding to the highly correlated image features to the one or more input medical images.

Illustrative embodiment 4. The computer-implemented method of any one of illustrative embodiments 1-3, wherein the machine learning based encoder network is trained by: receiving a training text-based query and one or more training medical images; encoding the training text-based query into training text features using the machine learning based text encoder network; encoding the one or more training medical images into a spatial hierarchy of training image features using the machine learning based image encoder network; selecting a subset of the spatial hierarchy of training image features based on correlations between particular features of the spatial hierarchy of training image features and the text features; training the machine learning based text encoder network for determining a correlation between input text features and input image features based on the text features and the selected subset of the spatial hierarchy of training image features; and outputting the trained machine learning based text encoder network.

Illustrative embodiment 5. The computer-implemented method of illustrative embodiment 4, wherein selecting a subset of the spatial hierarchy of training image features based on correlations between particular features of the spatial hierarchy of training image features and the text features comprises: determining a correlation between each feature of the spatial hierarchy of training image features and the text features; and selecting the features of the spatial hierarchy of training image features with a highest correlation as the subset of the spatial hierarchy of training image features.

Illustrative embodiment 6. The computer-implemented method of any one of illustrative embodiments 4-5, wherein selecting a subset of the spatial hierarchy of training image features based on correlations between particular features of the spatial hierarchy of training image features and the text features comprises: determining a correlation between each feature of the spatial hierarchy of training image features and image features of one or more example images known to be correlated with the training text-based query; and selecting the subset of the spatial hierarchy of training image features based on the correlation.

Illustrative embodiment 7. The computer-implemented method of any one of illustrative embodiments 4-6, wherein training the machine learning based text encoder network for determining a correlation between input text features and input image features based on the text features and the selected subset of the spatial hierarchy of training image features comprises: training the machine learning based text encoder network using contrastive learning.

Illustrative embodiment 8. The computer-implemented method of illustrative embodiment 7, wherein training the machine learning based text encoder network using contrastive learning comprises: training the machine learning based text encoder network using the selected subset of the spatial hierarchy of training image features and the text features as positive examples and unselected image features of the spatial hierarchy of training image features and the text features as negative examples.

Illustrative embodiment 9. The computer-implemented method of any one of illustrative embodiments 1-8, wherein the machine learning based text encoder network comprises a language model.

Illustrative embodiment 10. An apparatus comprising: means for receiving an input text-based query and one or more input medical images; means for encoding the input text-based query into text features using a machine learning based text encoder network; means for encoding the one or more input medical images into a spatial hierarchy of image features using a machine learning based image encoder network; means for determining a correlation between the text features and the spatial hierarchy of image features from a top-down of the spatial hierarchy of image features using the machine learning based text encoder network; and means for outputting the correlation between the text features and the spatial hierarchy of image features.

Illustrative embodiment 11. The apparatus of illustrative embodiment 10, wherein the means for determining a correlation between the text features and the image features from a top-down of the spatial hierarchy of image features using the machine learning based text encoder network comprises: means for determining a correlation score for each respective image feature of the spatial hierarchy of image features, the correlation score representing a correlation between the respective image feature and the text features.

Illustrative embodiment 12. The apparatus of illustrative embodiment 11, wherein the means for determining a correlation between the text features and the image features from a top-down of the spatial hierarchy of image features using the machine learning based text encoder network comprises: means for determining highly correlated image features of the spatial hierarchy of image feature based on the correlation scores; and means for mapping regions corresponding to the highly correlated image features to the one or more input medical images.

Illustrative embodiment 13. The apparatus of any one of illustrative embodiments 10-12, wherein the machine learning based encoder network is trained by: receiving a training text-based query and one or more training medical images; encoding the training text-based query into training text features using the machine learning based text encoder network; encoding the one or more training medical images into a spatial hierarchy of training image features using the machine learning based image encoder network; selecting a subset of the spatial hierarchy of training image features based on correlations between particular features of the spatial hierarchy of training image features and the text features; training the machine learning based text encoder network for determining a correlation between input text features and input image features based on the text features and the selected subset of the spatial hierarchy of training image features; and outputting the trained machine learning based text encoder network.

Illustrative embodiment 14. The apparatus of illustrative embodiment 13, wherein selecting a subset of the spatial hierarchy of training image features based on correlations between particular features of the spatial hierarchy of training image features and the text features comprises: determining a correlation between each feature of the spatial hierarchy of training image features and the text features; and selecting the features of the spatial hierarchy of training image features with a highest correlation as the subset of the spatial hierarchy of training image features.

Illustrative embodiment 15. A non-transitory computer-readable storage medium comprising instructions which, when executed by a computer, cause the computer to carry out operations comprising: receiving an input text-based query and one or more input medical images; encoding the input text-based query into text features using a machine learning based text encoder network; encoding the one or more input medical images into a spatial hierarchy of image features using a machine learning based image encoder network; determining a correlation between the text features and the spatial hierarchy of image features from a top-down of the spatial hierarchy of image features using the machine learning based text encoder network; and outputting the correlation between the text features and the spatial hierarchy of image features.

Illustrative embodiment 16. The non-transitory computer-readable storage medium of illustrative embodiment 15, wherein the machine learning based encoder network is trained by: receiving a training text-based query and one or more training medical images; encoding the training text-based query into training text features using the machine learning based text encoder network; encoding the one or more training medical images into a spatial hierarchy of training image features using the machine learning based image encoder network; selecting a subset of the spatial hierarchy of training image features based on correlations between particular features of the spatial hierarchy of training image features and the text features; training the machine learning based text encoder network for determining a correlation between input text features and input image features based on the text features and the selected subset of the spatial hierarchy of training image features; and outputting the trained machine learning based text encoder network.

Illustrative embodiment 17. The non-transitory computer-readable storage medium of illustrative embodiment 16, wherein selecting a subset of the spatial hierarchy of training image features based on correlations between particular features of the spatial hierarchy of training image features and the text features comprises: determining a correlation between each feature of the spatial hierarchy of training image features and image features of one or more example images known to be correlated with the training text-based query; and selecting the subset of the spatial hierarchy of training image features based on the correlation.

Illustrative embodiment 18. The non-transitory computer-readable storage medium of any one of illustrative embodiments 16-17, wherein training the machine learning based text encoder network for determining a correlation between input text features and input image features based on the text features and the selected subset of the spatial hierarchy of training image features comprises: training the machine learning based text encoder network using contrastive learning.

Illustrative embodiment 19. The non-transitory computer-readable storage medium of illustrative embodiment 18, wherein training the machine learning based text encoder network using contrastive learning comprises: training the machine learning based text encoder network using the selected subset of the spatial hierarchy of training image features and the text features as positive examples and unselected image features of the spatial hierarchy of training image features and the text features as negative examples.

Illustrative embodiment 20. The non-transitory computer-readable storage medium of any one of illustrative embodiments 15-19, wherein the machine learning based text encoder network comprises a language model.

Illustrative embodiment 21. A computer-implemented method comprising: receiving a training text-based query and one or more training medical images; encoding the training text-based query into training text features using a machine learning based text encoder network; encoding the one or more training medical images into a spatial hierarchy of image features using a machine learning based image encoder network; selecting a subset of the spatial hierarchy of image features based on correlations between particular features of the spatial hierarchy of image features and the text features; training the machine learning based text encoder network for determining a correlation between input text features and input image features based on the text features and the selected subset of the spatial hierarchy of image features; and outputting the trained machine learning based text encoder network.

Illustrative embodiment 22. The computer-implemented method of illustrative embodiment 21, wherein selecting a subset of the spatial hierarchy of image features based on correlations between particular features of the spatial hierarchy of image features and the text features comprises: determining a correlation between each feature of the spatial hierarchy of image features and the text features; and selecting the features of the spatial hierarchy of image features with a highest correlation as the subset of the spatial hierarchy of image features.

Illustrative embodiment 23. The computer-implemented method of any one of illustrative embodiments 21-22, wherein selecting a subset of the spatial hierarchy of image features based on correlations between particular features of the spatial hierarchy of image features and the text features comprises: determining a correlation between each feature of the spatial hierarchy of image features and image features of one or more example images known to be correlated with the training text-based query; and selecting the subset of the spatial hierarchy of image features based on the correlation.

1. A computer-implemented method comprising:
receiving an input text-based query and one or more input medical images;
encoding the input text-based query into text features using a machine learning based text encoder network;
encoding the one or more input medical images into a spatial hierarchy of image features using a machine learning based image encoder network;
determining a correlation between the text features and the spatial hierarchy of image features according to a top-down analysis of the spatial hierarchy of image features using the machine learning based text encoder network; and
outputting the correlation between the text features and the spatial hierarchy of image features.

2. The computer-implemented method of claim 1, wherein determining a correlation between the text features and the spatial hierarchy of image features according to a top-down analysis of the spatial hierarchy of image features using the machine learning based text encoder network comprises:
determining a correlation score for each respective image feature of the spatial hierarchy of image features, the correlation score representing a correlation between the respective image feature and the text features.

3. The computer-implemented method of claim 2, wherein determining a correlation between the text features and the image features according to a top-down analysis of the spatial hierarchy of image features using the machine learning based text encoder network comprises:
determining highly correlated image features of the spatial hierarchy of image feature based on the correlation scores; and
mapping regions corresponding to the highly correlated image features to the one or more input medical images.

4. The computer-implemented method of claim 1, wherein the machine learning based encoder network is trained by:
receiving a training text-based query and one or more training medical images;
encoding the training text-based query into training text features using the machine learning based text encoder network;
encoding the one or more training medical images into a spatial hierarchy of training image features using the machine learning based image encoder network;
selecting a subset of the spatial hierarchy of training image features based on correlations between particular features of the spatial hierarchy of training image features and the text features;
training the machine learning based text encoder network for determining a correlation between input text features and input image features based on the text features and the selected subset of the spatial hierarchy of training image features; and
outputting the trained machine learning based text encoder network.

5. The computer-implemented method of claim 4, wherein selecting a subset of the spatial hierarchy of training image features based on correlations between particular features of the spatial hierarchy of training image features and the text features comprises:
determining a correlation between each feature of the spatial hierarchy of training image features and the text features; and
selecting the features of the spatial hierarchy of training image features with a highest correlation as the subset of the spatial hierarchy of training image features.

6. The computer-implemented method of claim 4, wherein selecting a subset of the spatial hierarchy of training image features based on correlations between particular features of the spatial hierarchy of training image features and the text features comprises:
determining a correlation between each feature of the spatial hierarchy of training image features and image features of one or more example images known to be correlated with the training text-based query; and
selecting the subset of the spatial hierarchy of training image features based on the correlation.

7. The computer-implemented method of claim 4, wherein training the machine learning based text encoder network for determining a correlation between input text features and input image features based on the text features and the selected subset of the spatial hierarchy of training image features comprises:
training the machine learning based text encoder network using contrastive learning.

8. The computer-implemented method of claim 7, wherein training the machine learning based text encoder network using contrastive learning comprises:
training the machine learning based text encoder network using the selected subset of the spatial hierarchy of training image features and the text features as positive examples and unselected image features of the spatial hierarchy of training image features and the text features as negative examples.

9. The computer-implemented method of claim 1, wherein the machine learning based text encoder network comprises a language model.

10. An apparatus comprising:
means for receiving an input text-based query and one or more input medical images;
means for encoding the input text-based query into text features using a machine learning based text encoder network;
means for encoding the one or more input medical images into a spatial hierarchy of image features using a machine learning based image encoder network;
means for determining a correlation between the text features and the spatial hierarchy of image features according to a top-down analysis of the spatial hierarchy of image features using the machine learning based text encoder network; and
means for outputting the correlation between the text features and the spatial hierarchy of image features.

11. The apparatus of claim 10, wherein the means for determining a correlation between the text features and the spatial hierarchy of image features according to a top-down analysis of the spatial hierarchy of image features using the machine learning based text encoder network comprises:
means for determining a correlation score for each respective image feature of the spatial hierarchy of image features, the correlation score representing a correlation between the respective image feature and the text features.

12. The apparatus of claim 11, wherein the means for determining a correlation between the text features and the image features according to a top-down analysis of the spatial hierarchy of image features using the machine learning based text encoder network comprises:
means for determining highly correlated image features of the spatial hierarchy of image feature based on the correlation scores; and
means for mapping regions corresponding to the highly correlated image features to the one or more input medical images.

13. The apparatus of claim 10, wherein the machine learning based encoder network is trained by:
receiving a training text-based query and one or more training medical images;
encoding the training text-based query into training text features using the machine learning based text encoder network;
encoding the one or more training medical images into a spatial hierarchy of training image features using the machine learning based image encoder network;
selecting a subset of the spatial hierarchy of training image features based on correlations between particular features of the spatial hierarchy of training image features and the text features;
training the machine learning based text encoder network for determining a correlation between input text features and input image features based on the text features and the selected subset of the spatial hierarchy of training image features; and
outputting the trained machine learning based text encoder network.

14. The apparatus of claim 13, wherein selecting a subset of the spatial hierarchy of training image features based on correlations between particular features of the spatial hierarchy of training image features and the text features comprises:
determining a correlation between each feature of the spatial hierarchy of training image features and the text features; and
selecting the features of the spatial hierarchy of training image features with a highest correlation as the subset of the spatial hierarchy of training image features.

15. A non-transitory computer-readable storage medium comprising instructions which, when executed by a computer, cause the computer to carry out operations comprising:
receiving an input text-based query and one or more input medical images;
encoding the input text-based query into text features using a machine learning based text encoder network;
encoding the one or more input medical images into a spatial hierarchy of image features using a machine learning based image encoder network;
determining a correlation between the text features and the spatial hierarchy of image features according to a top-down analysis of the spatial hierarchy of image features using the machine learning based text encoder network; and
outputting the correlation between the text features and the spatial hierarchy of image features.

16. The non-transitory computer-readable storage medium of claim 15, wherein the machine learning based encoder network is trained by:
receiving a training text-based query and one or more training medical images;
encoding the training text-based query into training text features using the machine learning based text encoder network;
encoding the one or more training medical images into a spatial hierarchy of training image features using the machine learning based image encoder network;
selecting a subset of the spatial hierarchy of training image features based on correlations between particular features of the spatial hierarchy of training image features and the text features;
training the machine learning based text encoder network for determining a correlation between input text features and input image features based on the text features and the selected subset of the spatial hierarchy of training image features; and
outputting the trained machine learning based text encoder network.

17. The non-transitory computer-readable storage medium of claim 16, wherein selecting a subset of the spatial hierarchy of training image features based on correlations between particular features of the spatial hierarchy of training image features and the text features comprises:
determining a correlation between each feature of the spatial hierarchy of training image features and image features of one or more example images known to be correlated with the training text-based query; and
selecting the subset of the spatial hierarchy of training image features based on the correlation.

18. The non-transitory computer-readable storage medium of claim 16, wherein training the machine learning based text encoder network for determining a correlation between input text features and input image features based on the text features and the selected subset of the spatial hierarchy of training image features comprises:
training the machine learning based text encoder network using contrastive learning.

19. The non-transitory computer-readable storage medium of claim 18, wherein training the machine learning based text encoder network using contrastive learning comprises:
training the machine learning based text encoder network using the selected subset of the spatial hierarchy of training image features and the text features as positive examples and unselected image features of the spatial hierarchy of training image features and the text features as negative examples.

20. The non-transitory computer-readable storage medium of claim 15, wherein the machine learning based text encoder network comprises a language model.

21. A computer-implemented method comprising:
receiving a training text-based query and one or more training medical images;
encoding the training text-based query into training text features using a machine learning based text encoder network;
encoding the one or more training medical images into a spatial hierarchy of image features using a machine learning based image encoder network;
selecting a subset of the spatial hierarchy of image features based on correlations between particular features of the spatial hierarchy of image features and the text features;
training the machine learning based text encoder network for determining a correlation between input text features and input image features based on the text features and the selected subset of the spatial hierarchy of image features; and
outputting the trained machine learning based text encoder network.

22. The computer-implemented method of claim 21, wherein selecting a subset of the spatial hierarchy of image features based on correlations between particular features of the spatial hierarchy of image features and the text features comprises:
determining a correlation between each feature of the spatial hierarchy of image features and the text features; and
selecting the features of the spatial hierarchy of image features with a highest correlation as the subset of the spatial hierarchy of image features.

23. The computer-implemented method of claim 21, wherein selecting a subset of the spatial hierarchy of image features based on correlations between particular features of the spatial hierarchy of image features and the text features comprises:
determining a correlation between each feature of the spatial hierarchy of image features and image features of one or more example images known to be correlated with the training text-based query; and
selecting the subset of the spatial hierarchy of image features based the correlation.
